(19) United States
(12) Patent Application Publication
(10) Pub. No.: US 2024/0430121 A1
(43) Pub. Date: Dec. 26, 2024

(54) REAL-TIME MONITORING SYSTEM OF HOME APPLIANCES SOLD BY REGION AND METHOD FOR CONTROL THEREOF

(71) Applicant: LG ELECTRONICS INC., Seoul (KR)

(72) Inventors: Yong Hoan KWON, Seoul (KR); Seong In CHEONG, Seoul (KR); Jun Soo HAN, Seoul (KR); ILL SHIN KIM, Seoul (KR)

(73) Assignee: LG ELECTRONICS INC., Seoul (KR)

(21) Appl. No.: 18/707,449

(22) PCT Filed: Nov. 25, 2022
(86) PCT No.: PCT/KR2022/018904

§ 371 Date: May 3, 2024

(30) Foreign Application Priority Data
Nov. 25, 2021 (KR) 10-2021-0164421
Dec. 2, 2021 (KR) 10-2021-0170839
Jan. 18, 2022 (KR) 10-2022-0007138

(51) Int. Cl. H04L 12/28; G06Q 30/016

(52) U.S. Cl. CPC H04L 12/2803; G06Q 30/016; H04L 2012/2841

(57) ABSTRACT

A real-time monitoring system for home appliances according to an embodiment of the present disclosure may receive product information and a Wi-Fi address generated in a manufacturing process from a production management server according to production of a product, receive customer information for a user of the home appliance sold from a customer response app server according to selling/purchase of the product, matching the product information and the customer information corresponding to the Wi-Fi address with each other, and group the home appliances by region according to the Wi-Fi address to output a monitoring screen including the information on the home appliance to a display device.

### TECHNICAL FIELD

The present disclosure relates to a real-time monitoring system and a method for control thereof, and more particularly, to a monitoring system which identifies real-time product state information of home appliances sold by region, and a method for control thereof.

### BACKGROUND ART

In recent years, smart home appliances have emerged, and in terms of user convenience, a technology has been commercialized by directly controlling various functions of home appliances through that application when installing applications related to home appliances on user terminals.

However, if the home appliance is broken, a user must detect failure symptoms and then accept an A/S application to a manufacturer. The user describes the failure symptoms detected by the user's five senses, not the mechanical status information of the home appliance, and the consultant will schedule the A/S reception and repair schedule based on the user's description.

In most cases, the symptoms of home appliances detected by the user's five senses are unclear and subjective, so it is difficult to accurately accept the A/S situation, which may cause a waste of mis-service, re-service, or unnecessary service engineer outcalls.

### DISCLOSURE OF INVENTION

### Technical Problem

According to embodiments, a monitoring system can be provided, which during production, sales and use of home appliances and the life cycle after installation, preemptively groups home appliances according to the Wi-Fi address without the request of the customer, and identifies the information of home appliances through a real-time monitoring screen.

According to embodiments, a monitoring system of a home appliance can be provided, which can check whether the home appliances abnormally operates in real time, provide a preemptive customer service to the home appliances of which abnormality is sensed, and check whether the home appliance normally operates during a predetermined period after providing the service.

According to embodiments, a customer service providing system can be provided, which monitors a quality situation of a sold home appliance in real time, and provides the preemptive customer service to a customer when a defect occurs.

According to embodiments, a customer providing system can be provided, which can identify a product number and customer information of a home appliance without direct delivery of information of the home appliance by a user.

According to embodiments, a system can be provided, which identifies a geographical location of a home appliance by utilizing a Wi-Fi address of the home appliance to preemptively provide the customer service to the user.

According to embodiments, a system can be provided, which first identifies the geographical location of each home appliance to set an outcall service schedule at a shortest route based on an accurate location when outcall services of a plurality of home appliances are requested.

### Solution to Problem

According to an aspect, a real-time monitoring system for home appliances may receive product information and a Wi-Fi address generated in a manufacturing process from a production management server of the home appliance, receive customer information for a user of the home appliance from a customer response app server for the home appliance, matching the product information and the customer information corresponding to the Wi-Fi address with each other, and group the home appliances by region according to the Wi-Fi address to output a monitoring screen including the information on the home appliance to a display device.

According to an embodiment, the information on the home appliance may include at least one of the product information, the customer information, real-time state information of the home appliance, or information on an abnormal operation of the home appliance.

The monitoring screen may include a first area including one or more search items for searching for the home appliance and a second area displaying a home appliance list according to the search operation, and the one or more search items may include at least one of the product information, the customer information, a data collection period, real-time state information of the home appliance, or the information on the abnormal operation of the home appliance.

According to an embodiment, the product information may include at least one a manufacturing number, a model name, a production factory, a production line, a production date, or main component information, and the customer information may include at least one of a name, a phone number, an address, an email, an ID, a purchased home appliance mode name, a purchase date, or a purchased home appliance manufacturing number.

According to an embodiment, the real-time state information of the home appliance or the information on the abnormal operation of the home appliance may be generated based on sensor data collected in real time by a sensor included in the home appliance.

According to an embodiment, a real-time state of the home appliance or whether the home appliance abnormally operates may be received in response to sensing the abnormal operation of the home appliance by analyzing the sensor data from a home appliance diagnosis server.

According to an embodiment, the information on the abnormal operation of the home appliance may include at least one of an abnormal operation according to inexperienced use, an abnormal operation according to misuse, or an abnormal operation according to a failure.

According to an embodiment, a customer service may be provided to a user terminal specified according to customer information of the home appliance based on the information on the abnormal operation of the home appliance.

According to an embodiment, a subsequent measure of the customer service is provided by checking whether the home appliance abnormally operates from the home appliance diagnosis server after the customer service may be provided.

Another aspect, a customer service providing system for home appliances may monitor a real-time state of each home appliance based on sensor data collected by a sensor included in each home appliance identified by a Wi-Fi address, select at least one home appliance requiring providing a customer service according to the real-time state of each home appliance, and transmit a response guidance message for the customer service to each user terminal specified by customer information corresponding to at least one selected home appliance.

According to an embodiment, a customer service request may be received from the user terminal in response to the response guidance message for the customer service, the home appliance corresponding to the user terminal may be searched, and a monitoring screen for a real-time state of the searched home appliance may be output to a display device.

According to an embodiment, the abnormal operation for each home appliance may be sensed based on sensor data collected by a sensor included in each home appliance identified by a Wi-Fi address, and the customer service may be provided to the home appliance of which abnormal operation is sensed.

Yet another aspect, a method for providing a preemptive customer service based on geographical location information of a home appliance identified by a Wi-Fi address may include: receiving a visit service providing request for one or more home appliances of which abnormal operation is sensed while monitoring a plurality of home appliances; identifying a current location of each of the one or more home appliances based on Wi-Fi information of the one or more home appliances; classifying the one or more home appliances for each of one or more regions based on current locations of the one or more home appliances; setting a visit schedule for one or more home appliances included for each region; and providing a professional engineer outcall service according to the visit schedule.

According to an embodiment, a shortest route with the current location of each of one or more home appliances as a vertex may be searched by using a shortest route algorithm, and a professional engineer outcall service route may be set in response to the shortest route.

According to an embodiment, the Wi-Fi address may be a MAC address.

### Advantageous Effects of Invention

According to embodiments, a production management server provides information on a product to a monitoring service at the time of production of a home appliance, and a customer response app server provides information on a customer to the monitoring server at the time of selling of the home appliance to preemptively provide a customer service to a user before a user senses a phenomenon for an abnormal operation of the home appliance and applies for A/S.

According to embodiments, home appliances are grouped by region according to a Wi-Fi address to perform real-time monitoring for a home appliance group without an explicit request of the user while the home appliance is being used.

According to embodiments, when the A/S is accepted from the user of the home appliance, clear mechanical state information based on real-time sensor data of the home appliance is checked without relying on a failure state description by the user to enable a consultant to accurately accept the AS.

According to embodiments, the customer service is provided to the user by sensing the failure of the home appliance before a substantial damage occurs due to the failure of the home appliance to prevent the substantial damage.

According to embodiments, each of information on the home appliance and customer information is automatically transmitted to a customer service providing system from the production management server and the customer response app server, and the real-time quality situation of the home appliance is monitored to preemptively provide the customer service to the user who uses the home appliance.

According to embodiments, since the home appliance and customer information can be identified by the Wi-Fi address of the home appliance automatically transmitted by the production management server, when the preemptive customer service is provided to the customer or the customer service is requested from the customer, it is not necessary for the consultant to request a model number or a manufacturing number of the home appliance to the customer, so user convenience is increased and verbal information delivery is not required, so accurate information delivery can be guaranteed in a service consulting process.

According to embodiments, it is possible to accurately identify a geographical location of the home appliance without in an error range of 1 km by utilizing the Wi-Fi address of the home appliance without identifying a home appliance installation location (customer address) for the customer in order to provide the service for the home appliance.

According to embodiments, it is possible to manage monitoring for home appliances which belong to a predetermined range based on the Wi-Fi address of the home appliance, and as necessary, it is easy to set a visit schedule of a profession engineer.

### BRIEF DESCRIPTION OF DRAWINGS

FIG. 1 illustrates a network environment including a customer service providing system, a home appliance, and a user terminal according to an embodiment.

FIG. 2 illustrates an example in which the customer service providing system provides a customer service for the home appliance to the user terminal according to an embodiment.

FIG. 3 illustrates a block diagram of the customer service providing system according to an embodiment.

FIG. 4 illustrates a block diagram of the home appliance according to an embodiment.

FIGS. 5a and 5b illustrate an outcall service route for a plurality of home appliances.

FIG. 6 illustrates a group of a plurality of home appliances classified by region by the customer service providing system according to an embodiment.

FIG. 7 illustrates a home appliance group in which monitoring and customer services are provided by the customer service providing system according to an embodiment.

FIG. 8 illustrates an example of a screen of monitoring the home appliance by the customer service providing system according to an embodiment.

FIG. 9 illustrates an example of a detailed information screen of a home appliance of which operation abnormality is discovered by the customer service providing system according to an embodiment.

FIG. 10 illustrates an example of a monitoring screen of the customer service providing system according to an embodiment.

FIG. 11 illustrates an example of a region-specific list screen of the customer service providing system according to an embodiment.

FIG. 12 illustrates an example of a home appliance detailed information screen to provide the service of the customer service providing system according to an embodiment.

FIG. 13 illustrates a flowchart of a customer service providing method by a user request according to an embodiment.

FIG. 14 is a flowchart of a method for managing a plurality of home appliances by real-time monitoring by a customer service providing system according to an embodiment.

FIG. 15 illustrates a flowchart of a method for monitoring a home appliance in real time by the customer service providing system according to an embodiment.

FIG. 16 illustrates a flowchart of a method for providing a customer service in response to a failure of a home appliance according to an embodiment.

### MODE FOR THE INVENTION

Hereinafter, embodiments will be described in detail with reference to the accompanying drawings. However, the claims are not restricted or limited by the embodiments. Like reference numerals illustrated in the respective drawings designate like members.

The terms used in the following description are selected as common and universal in the related technical field, but there may be other terms depending on the development and/or change of technology, and the preference of customary technicians. Therefore, the terms used in the description below should not be understood as limiting technical ideas, and should be understood as an exemplary term for explaining embodiments.

Further, in a specific case, a term which an applicant arbitrarily selects is present and in this case, a meaning of the term will be disclosed in detail in a corresponding description part. Accordingly, a term used in the description below should be defined based on not just a name of the term but a meaning of the term and contents throughout the present disclosure.

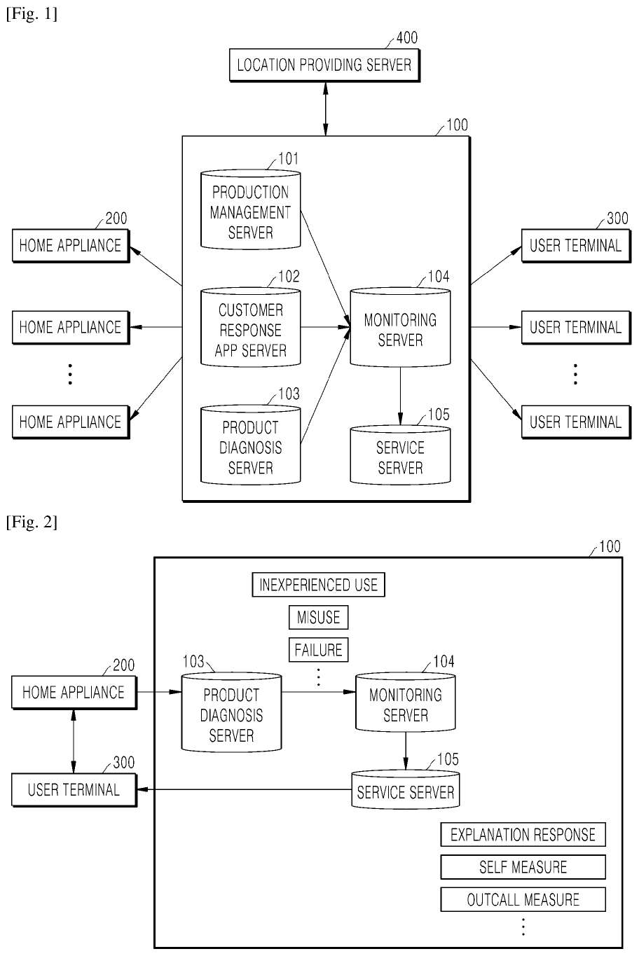

FIG. 1 illustrates a network environment including a customer service providing system, a home appliance, and a user terminal according to an embodiment.

According to an embodiment, a customer service providing system 100 may monitor a state and an abnormality of a home appliance 200 according to production, installation, and use life cycle of each home appliance 200. The customer service providing system 100 may transmit a response guide message to a user terminal 300 based on customer information upon occurrence of a failure. The customer service providing system 100 may include a production management server 101, a customer response app server 102, a production diagnosis server 103, a monitoring server 104, and a service server 105.

The production management server 101 may generate production information according to the production of the home appliance 200, and transmit production information to the monitoring server 104. The product information may include a manufacturing number, a model name, a production factory, a production line, a production date, or main component information. The main component information may include, for example, a Wi-Fi address (MAC address) of a communication device provided in the product.

The home appliance 200 may set communication with the user terminal 300 through a customer response app installed in a terminal 300 of a purchaser (or user) according to selling, and use installation. For example, information on wireless Internet connection may be set through the customer response app installed in the terminal 300 of a purchaser, and the home appliance 200 may communicate with the terminal 300 of the purchaser or the product diagnosis server according to the set wireless Internet connection. While the home appliances 200 operates, real-time sensor data collected by one or more sensors embedded in the home appliance may be transmitted to the product diagnosis server 103.

The monitoring server 104 may receive product information for all produced home appliances from the production management server 100. For example, information on a home appliance produced that day may be received once a day. The monitoring server 104 may receive the customer information fro the customer response app server 102. For example, production installation and using registration may be performed, and the customer information may be input by using the customer response app according to the purchase of the product. The customer response app server 102 may transmit the input customer information to the monitoring server 104.

The product diagnosis server 103 analyzes the real-time sensor data received from the home appliance 200 by using a diagnosis engine to identify a current state of the home appliance 200, and sense whether the operation is abnormal. The product diagnosis server 103 may periodically transmit current state information and abnormal operation information of the home appliance 200 to the monitoring server 104.

The diagnosis engine may detect data which deviates from a normal operation range by debugging data, and for example, when the home appliance 200 is a refrigerator product, the diagnosis engine may sense a failure of a freezer when freezing temperature data is higher than a set reference. The diagnosis engine may define an abnormal operation type according to the type of home appliance 200, and use a reference value to determine an abnormal state by accumulation of the sensor data. By those skilled in the art to which the present disclosure belongs, the processor 110 may define algorithms for a normal operation, an abnormal operation, the failure, etc., from the debugging data for the home appliance 200.

The product diagnosis server 103 may transmit diagnosis information of the service server 105 by sensing the failure of the home appliance 200, and the service server 105 may provide, for example, a professional engineer visit service based on the diagnosis information. The customer service providing system 100 may distribute providing of the customer service to each home appliance 200 to a plurality of (e.g., m) service servers allocated to regions classified based on a geographical location identified by using the location providing server 400 in response to IP addresses of a plurality of (e.g., n) home appliances 200.

The customer service providing system 100 receives both the manufacturing information such as the manufacturing number, etc., and the Wi-Fi address information of the home appliance 200 from the production management server 104 of the home appliance 200 to identify the plurality of home appliances 200 through the Wi-FI addresses. The production management server 104 may transmit the information on the produced home appliance 200 to the customer service providing system 100 in bulk at a predetermined period. The product diagnosis server 103 may receive the sensor data acquired from one or more sensor data included in the home appliance 200 from the home appliance 200 at a predetermined period, and diagnosis a mechanical state of the home appliance 200 based on the sensor data. When the customer service is required based on the mechanical state of the home appliance 200, the product diagnosis server 103 may transmit information on the relevant home appliance 200 to the service server 105.

In an embodiment, the customer service providing system 100 may manage the plurality of (e.g., n) home appliances 200 by region, and request providing of the service for each home appliance 200 to the plurality of (e.g., m) service providing server (e.g., service servers 105) distinguished by region. For example, the customer service providing system 100 positioned in the US allocates the service server 105 by state, and identifies the geographical locations of the home appliances 200 to provide the customer service through the service server 105 allocated to the relevant state.

In an embodiment, the customer service providing system 100 may identify the geographical locations of the home appliances 200 by using the IP address (Wi-Fi MAC addresses) of the respective home appliances 200, and distribute customer service providing to the respective home appliances 200 to the respective service providing severs (e.g., m service providing servers) according to the identified geographical locations. The customer service providing system 100 may request geographical location information corresponding to the IP address to the location providing server 400. The location providing server 500 may identify a region (a city, a state, a post number, and a nation) at which the relevant IP is positioned with respect to the IP address. For example, the location providing server 500 may identify a geographical location of si/gu/dong according to the nation and an administrative district within an error range of 1 km in response to the IP address. The customer service providing system 100 may provide the customer service based on an accurate geographical location. In order to provide the customer service, the customer service providing system 100 need not identify the mechanical state of the home appliance or identify an address in which the home appliance 200 is installed to the user of the home appliance 200.

The monitoring server 104 identifies the information on the purchased home appliance between the product information received from the production management server 101 and the customer information received from the customer response app server 102 to match the product information and the customer information corresponding to the Wi-Fi address with each other. The monitoring server 104 groups the home appliances by region according to the Wi-Fi address to output a monitoring screen including the information on the home appliance to a display device. For example, the monitoring server 104 may list up all refrigerator products sold in the US according to the Wi-Fi address and output the refrigerator products on the monitoring screen. The monitoring server 104 may transmit the information on the home appliance 200 requiring the customer service to the service server 105 distinguished by region. For example, when the abnormal operation is sensed in the home appliance 200 which is sold and operated in the US, the monitoring server 104 may transmit the abnormal operation information for the relevant home appliance 200, and the related product information, and customer information to the service server 105 providing the A/S for the US.

A plurality of service servers 105 may be installed by selling region of the home appliance 200, and the service server 105 displays the information on the home appliance 200 in the relevant region to the display device to allow the consultant to use the information upon consulting for providing the A/S for the home appliance 200.

FIG. 2 illustrates an example in which the customer service providing system provides a customer service for the home appliance to the user terminal according to an embodiment. While the home appliance 200 operates, sensor data (e.g., in the case of the refrigerator, refrigeration temperature and freezing temperature data) collected by one or more sensors (e.g., in the case of the refrigerator, temperature sensors) installed in the home appliance 200 may be transmitted to the product diagnosis server 103 at a predetermined period. The product diagnosis server 103 compares the sensor data received by the home appliance 200 and normal operation data, and when the sensor data deviates from a predetermined range, the product diagnosis server 103 may determine that the operation is abnormal. The product diagnosis server 103 may determine the normal range of the normal operation data by utilizing the debugging data upon manufacturing the home appliance 200 or by accumulating the sensor data for the home appliance 200. The product diagnosis server 103 may analyze a cause such as inexperienced use, misuse, failure, etc., for the abnormal operation of the home appliance 200, and transmit the information on the abnormal operation to the monitoring server 104. The monitoring server 104 may identify the home appliance 200 of which abnormal operation information is received among a plurality of home appliances to be monitored by the Wi-Fi address and determine whether to provide the customer service. For the home appliance 200 of which customer service is to be determined to be required, the monitoring server 104 may specify the user terminal 300 based on the customer information, and request providing the customer service to the service server 105. The service server 105 may provide customer services such as explanation response, self-measure guidance, outcall action reservation, etc., to the user terminal 300. The customer service providing system 100 may identify each home appliance by the Wi-Fi address from the time of manufacturing the home appliance 200, and immediately react to the abnormal operation of the home appliance 200, and preemptively provide the customer service to the user terminal 300. User damage according to the failure of the home appliance may be minimized.

FIG. 3 illustrates a block diagram of the customer service providing system according to an embodiment. The customer service providing system 100 may include the production management server 101, the customer response app server 102, the production diagnosis server 103, the monitoring server 104, and the service server 105 functionally classified as illustrated in FIG. 1, and may include a processor 110, a memory 120, a display device 130, a communication module 140, and a bus 150 as physical components.

The processor 110 as a kind of central processing unit may control an operation of the customer service providing system 100 by executing one or more command stored in the memory 120. The processor 110 may include all types of devices capable of processing data. The processor 110 may mean, for example, a data processing device embedded in hardware, which has a physically structurized circuit in order to perform a function expressed by a code or a command included in the program. As such, an example of the data processing device embedded in the hardware may include a processing device such as a Microprocessor, a Central Processing Unit (CPU), a Processor core, a Multiprocessor, an Application-Specific Integrated Circuit (ASIC), A Field Programmable Gate Array (FPGA), etc., but the scope of the present disclosure is not limited thereto. The processor 110 may include one or more processors. The processor 110 may include at least one core.

The processor 110 may monitoring the real-time state of each home appliance 200 based on the sensor data collected by the sensor included in each home appliance 200 identified by the Wi-Fi address. The processor 110 may select at least one home appliance 200 requiring providing the customer service according to the real-time state of each home appliance 200. The processor 110 may identify the customer information corresponding to the home appliance 200 determined to require providing the customer service, and transmit a guidance message corresponding to the customer service to each user terminal specified according to the customer information. The processor 110 may receive the customer information acquired through the application installed in the user terminal 300, and match the customer information with the home appliance 200 which matches the Wi-Fi address of the purchased home appliance 200 included among the respective home appliances 200 identified by the Wi-Fi address. The Wi-Fi address may be an MAC address. The processor 110 may receive the customer service request from the user terminal 300 in response to the response guidance message for the customer service. The processor 110 may search for the home appliance 200 corresponding to the user terminal 300 requiring the customer service, and output the monitoring screen for the real-time state of the searched home appliance 200 to the display device 130. The processor 110 may sense the abnormal operation for each home appliance 200 based on the sensor data collected by the sensor included in each home appliance 200 identified by the Wi-Fi address. The processor 10 compares the sensor data and the normal operation data of the home appliance 200 to sense the abnormal operation when the sensor data deviates from a predetermined range. The processor 110 may detect data which deviates from a normal operation range by debugging data, and for example, when the home appliance 200 is a refrigerator product, the diagnosis engine may sense a failure of a freezer when freezing temperature data is higher than a set reference. The processor 110 may define a reference for the abnormal operation according to the type of home appliance 200, and a determination reference for the abnormal operation may be changed by accumulation of the sensor data collected while the home appliance 200 operates. By those skilled in the art to which the present disclosure belongs, the processor 110 may define algorithms for a normal operation, an abnormal operation, the failure, etc., from the debugging data for the home appliance 200. The processor 110 may provide the customer service to the home appliance 200 of which abnormal operation is sensed. The processor 110 may receive the customer service request and the Wi-Fi address for the home appliance 200 which is being used from the user terminal 300, search for the home appliance 200 which matches the received Wi-Fi address among the respective home appliances 200 identified by the Wi-Fi, and output the monitoring screen for the real-time state of the searched home appliance 200 to the display device 130.

The memory 120 may include an internal memory and/or an external memory, and may include a volatile memory such as a DRAM, an SRAM, or an SDRAM, a nonvolatile memory such as a One Time Programmable Read Only Memory (OTPROM), a Programmable Read Only Memory (PROM), an Erasable PROM (EPROM), an Electrically Erasable PROM (EEPROM), a mask ROM, a flash ROM, a NAND flash memory, or a NOR flash memory, a flash memory such as a solid state driver (SSD), a compact flash (CF) card, an SD card, a micro-SD card, a mini-SD card. an Xd card, or a memory stick, or a storage device such as a hard disk drive (HDD). The memory 120 may include magnetic storage media or a flash storage media, but is not limited thereto.

The memory 120 may include information on a plurality of home appliances 200. For example, the manufacturing number, product serial number, communication identification information (e.g., Wi-Fi MAC address), production factory, production time point, production line, component type, type of product, detailed component information, etc., may be received from the production management server of the home appliance 200, and stored in the memory 120. The memory 120 may receive the customer information through a plurality of user terminals 300 or the application installed in the user terminal 300. For example, the customer information may include information such as purchasing product information, purchasing product identification information, purchase date, purchase store, name, address, phone number, email address, member ID, member password, etc., and may be stored in the memory 120.

The display device 130 may visually provide the information to the outside (e.g., administrator) of the customer service providing system 100. The display device 130 may include, for example, a display, a hologram device, or a projector and a control circuit for controlling the corresponding device. According to an embodiment, the display device 130 may include a touch circuitry configured to sense a touch or a sensor circuitry (e.g., a pressure sensor) configured to measure an intensity of force generated by the touch.

The display device 130 may display information on at least one home appliance of which abnormal operation is sensed and customer information with respect to the sensor data received from the plurality of home appliances 200.

The communication module 140 may support establishment of a direct (e.g., wired) communication channel or a wireless communication channel between the customer service providing system 100 and the external electronic device (e.g., the home appliance 200 or the user terminal 300) and communication execution through the established communication channel. The communication module 140 may include one or more communication processors which are operated independently from the processor 110 (e.g., the application processor) and support one or more communication processors supporting the direct (e.g., wired communication) or the wireless communication. According to an embodiment, the communication module 140 may include a wireless communication module (e.g., a cellular communication module, a short-range wireless communication module, or a global navigation satellite system (GNSS) communication module) or a wireless communication module (e.g., a local area network (LAN) communication module, or a power line communication module). Among the communication modules, the relevant communication module may communicate with the external electronic device through the network. The network may include at least one of a short-range communication network cellular network such as Bluetooth, WiFi direct, or infrared data association (IrDA), the Internet, or a computer network (e.g., a long-range communication network such as LAN or WAN). The types of communication modules may be integrated into one component (e.g., single chip), or may be implemented as a plurality of separate components (e.g., plural chips).

The bus 150 is a logical/physical path connecting the processor 110, the memory 120, the display device 130, and the communication module 140. The processor 110 may perform read/write from/to the memory 120 through the bus 150.

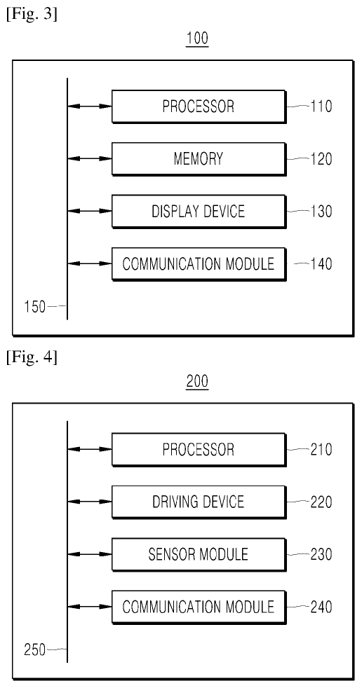

FIG. 4 illustrates a block diagram of the home appliance according to an embodiment. The home appliance 200 may include a processor 210, a driving device 220, a sensor module 230, a communication module 240, and a bus 250.

The processor 210 as a kind of central processing unit may include the driving device 220, the sensor module 230, and the communication module 240. The home appliance 200 may process a series of predetermined operations by executing one or more predetermined commands in response to application of power.

The driving device 220 may include various devices required for operating the home appliance 200. For example, when the home appliance 200 is the refrigerator, the driving device 220 may include a compressor, a condenser, an expansion member, a refrigeration room evaporator, a freezing room evaporator, a refrigeration room fan, and a freezing room fan.

The sensor module 230 may include one or more sensors. For example, when the home appliance 200 is the refrigerator, the sensor module 230 may include a refrigeration room temperature sensor, a freeing room temperature sensor, a door sensor, a compressor sensor sensing an operating pattern of the compressor, an ice sensor sensing an ice use amount and an ice state, a water amount and water pressure sensor sensing a use amount and a pressure of water, and a defrost sensor sensing a defrost cycle, and a defrost state.

The communication module 240 may network-communicate with the external electronic device. For example, the communication module 240 may be network-connected to peripheral devices through the short-range wireless communication (e.g., Bluetooth, WiFi direct, or infrared data association (IrDA)). In various embodiments, the home appliance 200 may be Bluetooth-connected to the user terminal 300 by using the communication module 240, and may establish a Wi-Fi connection by using a wireless Internet providing device positioned therearound. The communication module 240 may have unique identification information, and may be assigned with the Wi-Fi MAC address, for example.

The processor 210 may identify the real-time sensor data collected by the sensor module 230, and transmit data of a predetermined item among the collected sensor data to the customer service providing system 100 by using the communication module at a predetermined period.

The bus 250 is a logical/physical path connecting the processor 210, the driving device 220, the sensor module 230, and the communication module 240. The processor 110 may transmit a control signal to the driving device 220, the sensor module 230, or the communication module 240 through the bus 250.

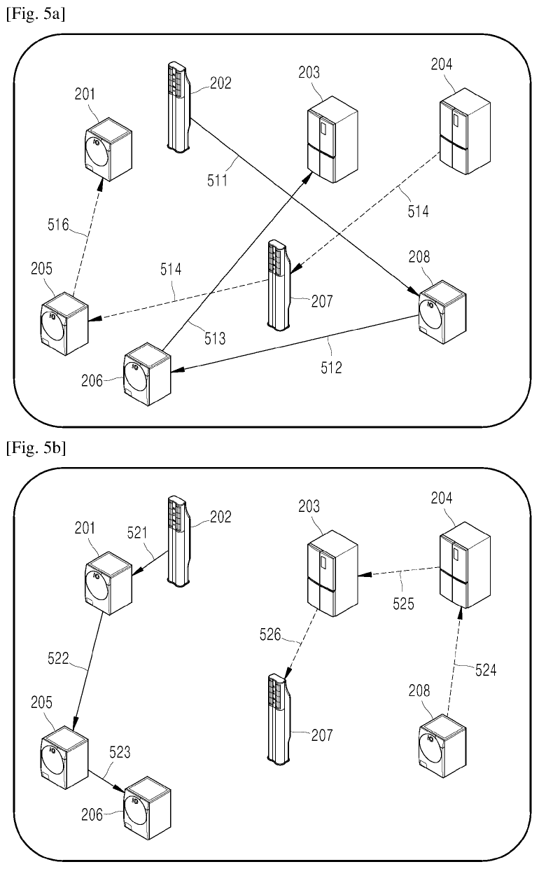

FIGS. 5a and 5b illustrate an outcall service route for a plurality of home appliances. FIG. 5a illustrates a service path of the outcall service route set in the related art and FI. 5b illustrates an example of the outcall service route according to an embodiment of the present disclosure.

With respect to the outcall service of the professional engineer, a visit schedule may be set in a time order for a plurality of home appliances (e.g., reference numerals 201 to 208) of which customer service requests are accepted. In the related art, the visit schedule is set and an outcall route is determined according to the customer service request. For example, referring to FIG. 5a, an outcall route (solid lines 511 to 513) of engineer A may be set to in the order of the home appliance 202, the home appliance 208, the home appliance 206 and the home appliance 203, and an outcall route (solid lines 514 to 516) of engineer B may be set to in the order of the home appliance 204, the home appliance 207, the home appliance 205 and the home appliance 201. In the case of FIG. 5a, it can be seen that since the geographical locations of the home appliances are not considered, movement lines of both engineers A and B are inefficient even by intuitive determination. Unlike this, the customer service providing system 100 according to an embodiment of the present disclosure may first identify the geographical location of each home appliance, and then explores a shortest route and set the visit schedule as outcall service reservations for the plurality of home appliances are requested. Referring to FIG. 5b, an outcall route (solid lines 521 to 523) of engineer A may be set to in the order of the home appliance 202, the home appliance 201, the home appliance 205 and the home appliance 2063, and an outcall route (solid lines 524 to 526) of engineer B may be set to in the order of the home appliance 208, the home appliance 204, the home appliance 203 and the home appliance 207. When the outcall routes of FIGS. 5a and 5b are compared with each other, it can be identified that total lengths of the routes of both engineers A and B are reduced, so the movement line may be efficiently set. According to embodiments, it is an apparent effect that the outcall route is efficiently set to increase the number of home appliances to which the customer service may be provided at the same time period, and the customer service providing time period also increases to provide a high-quality customer service to multiple customers. Furthermore, even upon the customer service providing request according to a home appliance failure repairing acceptance by the user, the service server 105 may identify information on the home appliance 200 matching the user device 300 through the customer response app server 102. The service server 105 may identify the installation location of the home appliance 200 through the location providing server 400 by using the Wi-Fi address identified according to the home appliance 200. The service server 105 identifies the real-time diagnosis state of the home appliance 200 through the product diagnosis server 103 to self-identify accurate information without the explanation by the customer and rapidly provide an efficient customer service.

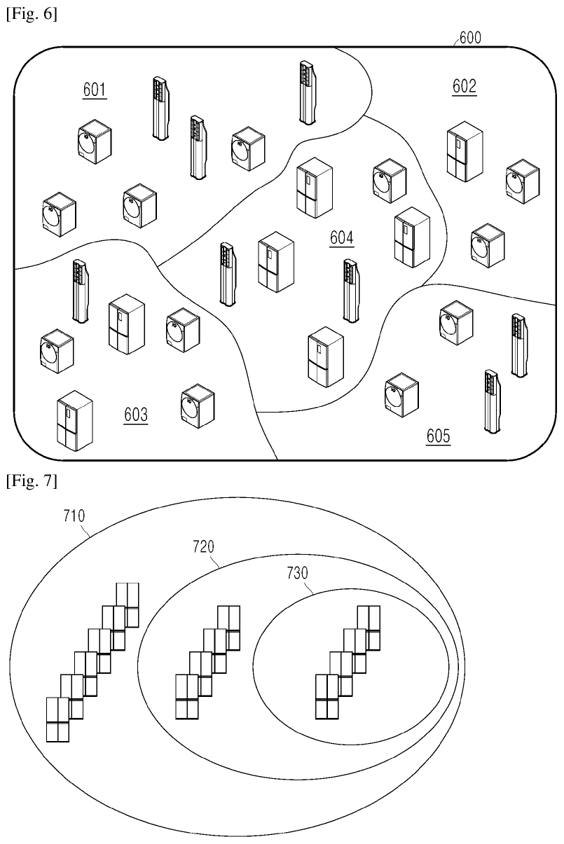

FIG. 6 illustrates a group of a plurality of home appliances classified by region by the customer service providing system according to an embodiment. The customer service providing system 100 according to an embodiment may classify the plurality of home appliances by two or more regions based on the Wi-Fi addresses capable of identifying the plurality of home appliances and manage the plurality of home appliances by one or more groups for efficiency of management. Referring to FIG. 6, the customer service providing system 100 may classify the plurality of home appliances 600 into a total of five groups, i.e., a first group 601 to a fifth group 605 based on the geographical locations of the plurality of home appliances 600. The customer service providing system 100 may allow the service server 105 managing the relevant region to process the customer service when the customer service request for the home appliances included in the fourth group 604 is made. In various embodiments, each group range may be determined according to various references, and for example, the region may be designated according to a range in which the professional engineer may move within one day.

FIG. 7 illustrates a home appliance group in which monitoring and customer services are provided by the customer service providing system according to an embodiment. The customer service providing system 100 may acquire the manufacturing information at the time of manufacturing the home appliance 200 and receive the sensor data at a predetermined period when using the home appliance 200 is started, and receive the customer information when the user of the home appliance 200 conducts customer registration for the purchase home appliance 200 through a predetermined application. The customer service providing system 100 may receive the manufacturing information for the home appliance included in the first group 710 from the production management server 101 at the time of manufacturing the home appliance 200. The customer service providing system 100 may store a manufacturing number, a model name, a production factory, a production line, a production date, or main component information for the first group 710 in the memory 120.

The customer service providing system 100 may receive the real-time sensor data from the second group 720 which is sold and installed in the first group 710. The customer service providing system 100 may store real-time sensor data capable of identifying the product state for the second group 720 in the memory 120. The customer service providing system 100 may acquire customer information for the third group 730 for which the customer performs product registration through the application installed in the user terminal 300 in the second group 720. The customer service providing system 100 may store all of the product information, the real-time sensor data, and the customer information for the third group 730 in the memory 120. In various embodiments, the customer services which the customer service providing system 100 may provide to the first to third groups may be different. When customer product registration is performed during the lifecycle such as production, selling, use, etc., of the home appliance or the real-time sensor data is transmitted, the relevant home appliance may belong to the third group 730.

FIG. 8 illustrates an example of a screen of monitoring the home appliance by the customer service providing system according to an embodiment. The customer service providing system 100 may sense the abnormal operation of the home appliance 200 based on the sensor data received from the plurality of home appliances 200, and store the sensed abnormal operation state information in the memory 120. The customer service providing system 100 may display the monitoring screen for displaying the information on the home appliance 200 on the display device 130 as illustrated in FIG. 8 in order to allow the administrator to provide the customer service to the plurality of home appliances 200. The monitoring screen may include a first area 810 displaying a search item for a monitored product and a second area 820 displaying a search result among the monitored products. The search item may include a category, a product type, a diagnosis period, a real-time state, a customer name, a Wi-Fi address, a model name, a phone number, an email, etc. The customer service providing system 100 may search for, for example, the phone number among the searched items, and output information on a product possessed by the customer among the monitored products to the second area 820. The customer service providing system 100 searches for the failure or a warning in the real-time state to identify a product of which abnormal operation is sensed among the monitored products. For example when the number of home appliances in the failure state is 3 and the number of home appliances in the warning state is 8 among a total of 150269 monitored products, the number of home appliances of which failure is discovered and the number of home appliances in the warning state may be output to the second area 820, and the home appliances in the failure or warning state may be listed up and displayed.

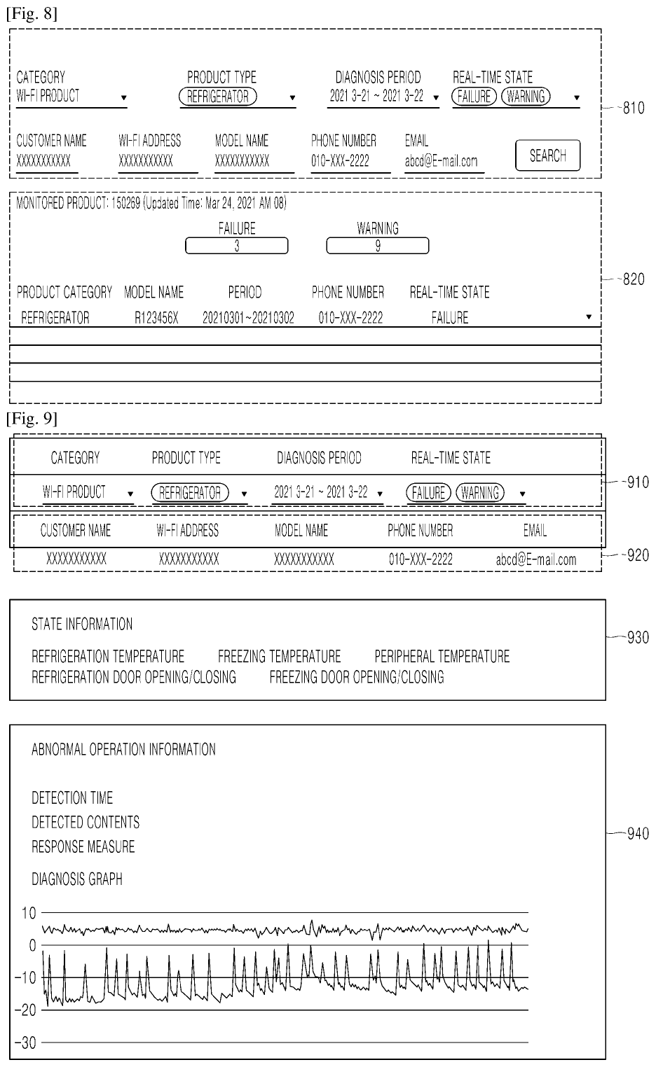

FIG. 9 illustrates an example of a detailed information screen of a home appliance of which operation abnormality is discovered by the customer service providing system according to an embodiment. The customer service providing system 100 may display detailed information on a specific home appliance 200 through the display device 130. For example, the customer service providing system 100 may output detailed information on a home appliance clicked by the user among the home appliances displayed in the search result list in FIG. 8. In various embodiments, a detailed information screen may include a first area 910, displaying information on the home appliance, a second area 920, displaying the customer information, a third area 930 displaying the product state, and a fourth area 940 displaying the abnormal operation information.

The customer service providing system 100 may display product information stored in the memory 120 for the home appliance in the first area 910. For example, the product information may include a product category, a product type, a diagnosis period, a real-time state, a selling region, product identification information, a detected abnormal operation item name, a detected abnormal operation item type, a control web application name, a product selling name, a sensor data sending date, etc.

The customer service providing system 100 may display customer information stored in the memory 120 in the first area 920. For example, the customer information may include a customer name, a Wi-Fi address, a model name of a purchased home appliance, a phone number, an email address, a purchase date, etc.

The customer service providing system 100 may display detailed items representing the product state in the third area 930. The customer service providing system 100 may digitize and display a current state of the home appliance based on the sensor data received from the home appliance 200. For example, the detailed items may be displayed, which include a refrigeration room temperature, a freezing room temperature, a peripheral temperature, the number of refrigeration room door opening/closing times for a day, the number of freezing room door opening/closing times for a day, etc.

The customer service providing system 100 may display abnormal operation information for the home appliance 200 in the fourth area 940. For example, the customer service providing system 100 may display a detection time, detected contents, a response measure, and a diagnosis graph for the abnormal operation which occurs for the home appliance 200.

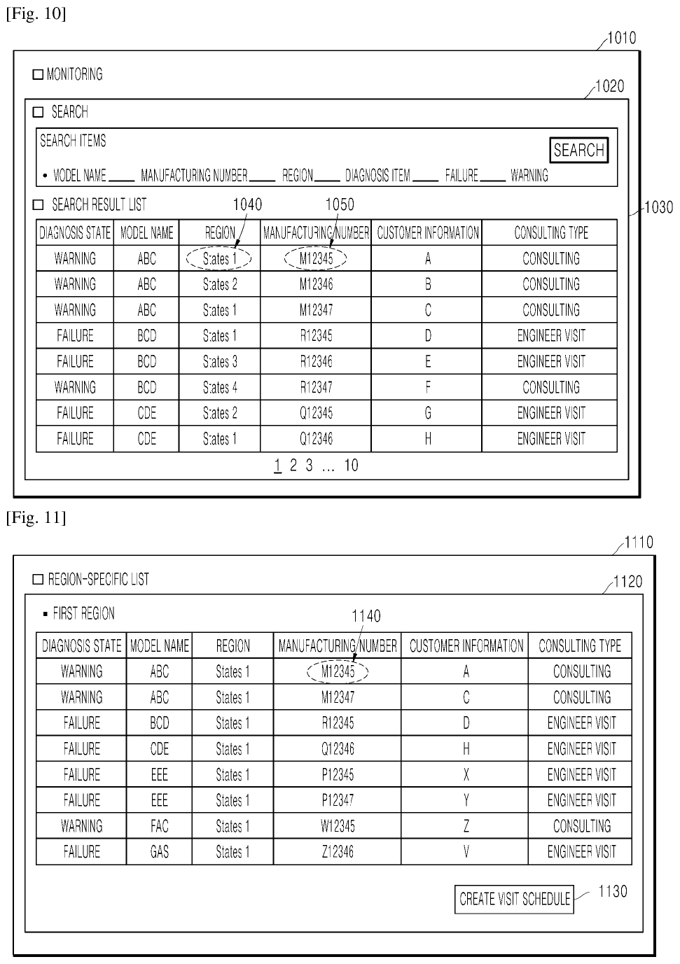

FIG. 10 illustrates an example of a monitoring screen of the customer service providing system according to an embodiment. The customer service providing system 100 may sense a diagnosis abnormality for the plurality of home appliances 200 in the product diagnosis server 103, and monitor the result in real time. Referring to FIG. 10, a monitoring screen may include a search area 1020 and a search result list area 1030.

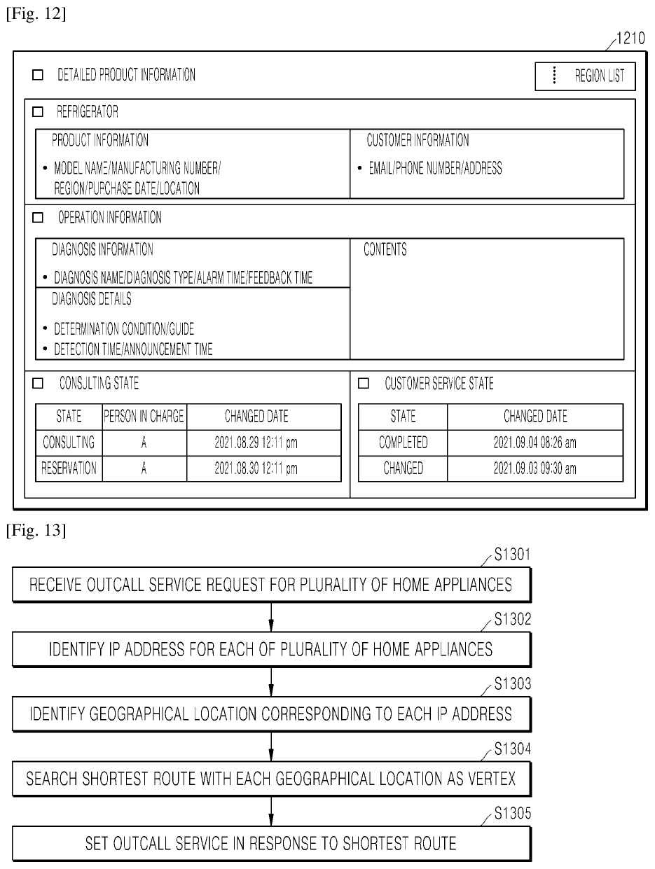

Products corresponding to any one search item among the model name, the manufacturing number, the region, the diagnosis item, the failure, and the warning may be searched among products to be monitored in the search are 1020. The product list searched in the search result list 1030 may be displayed, and for example, the diagnosis state, the model name, the region, the manufacturing number, the customer information, and the consulting type may be displayed as in FIG. 10. The customer service providing system 100 may provide the customer service for the searched product list in the service server 105 corresponding to each region. For example, the first service server 105 corresponding to states 1 may provide a consulting service or an engineer visit service for products of which warning or failure is sensed among monitored products included in states 1. In an embodiment, the monitored products included in states 1 may be displayed as a list as in FIG. 9 in response to an operation of clicking on a region item, e.g., states 1 1040 in the search result list. Further, the detailed information screen for the relevant product may be displayed as in FIG. 12 in response to an operation of clicking on Manufacturing number M12345 1050 in the search result list.

FIG. 11 illustrates an example of a region-specific list screen of the customer service providing system according to an embodiment. The customer service providing system 100 may provide various customer services for the product requiring the customer service among the monitored products in the relevant region through the service server 105 for each region.

A region-specific list screen 1110 may display a monitored product list 1120 for each region, and referring to FIG. 11, the products of which warning or failure is sensed by the product diagnosis server 103 may be listed up among the monitored products included in states 1. The service server 105 may create a visit schedule for products requiring a professional engineer visit service. For example, when a “create visit schedule 1130” button is click in the region-specific list screen, the visit schedule may be created by determining positional information of each product. In an embodiment, the visit schedule may be created as in FIG. 5b.

The detailed information screen for the relevant product may be displayed as in FIG. 12 in response to an operation of clicking on Manufacturing number M12345 1140 in the search result list.

FIG. 12 illustrates an example of a home appliance detailed information screen to provide the service of the customer service providing system according to an embodiment. The customer service providing system 100 may display a detailed information screen 1210 for any one home appliance among products to be monitored.

The detailed product information screen may display the product information and the customer information according to the product type, and include operation information sensed by the product diagnosis server 103, and display a consulting state and a customer service providing state when providing the customer service is required. In the region and the location in the product information, an accurate current location in which the home appliance is installed may be acquired through the location providing server 400 based on Wi-Fi information of the home appliance.

FIG. 13 illustrates a flowchart of a customer service providing method by a user request according to an embodiment.

In step S1301, the customer service providing system 100 may receive the outcall service request for at least one home appliance identified by the Wi-Fi address. The Wi-Fi address of the home appliance may be received in bulk from the production server of the home appliance at a predetermined period, and the Wi-Fi address may be the MAC address. The outcall service request for the home appliance may be generated in response to sensing the abnormal operation based on the real-time sensor information of the home appliance.

In step S1302, the customer service providing system 100 may identify each geographical location corresponding to the Wi-Fi address of at least one home appliance. The customer service providing system 100 may classify at least one home appliance into one or more groups based on the geographical location. In an embodiment, one or more home appliances included in a region of a predetermined range may be managed as a group.

In step S1303, the customer service providing system 100 may search the shortest route with each geographical location as a vertex by using a shortest route algorithm. The customer service providing system 100 may search the shortest route for each group classified by the geographical location. In an embodiment, each shortest route with the home appliance included in each group as the vertex may be searched. The shortest route algorithm may be variously implemented, and a required variable may be included in the shortest route as a weight. For example, damage may be minimized, which occurs when repairing of the home appliance is delayed by reflecting an urgent degree of repairing of the home appliance as the weight.

In step S1304, the customer service providing system 100 may set the route of the outcall service in response to the shortest route. The customer service providing system 100 may provide the visit service to the customer through the profession engineer in response to the outcall service route. The professional engineer may be multiple persons, and in various embodiments, the outcall service route may be divided and assigned to each professional engineer.

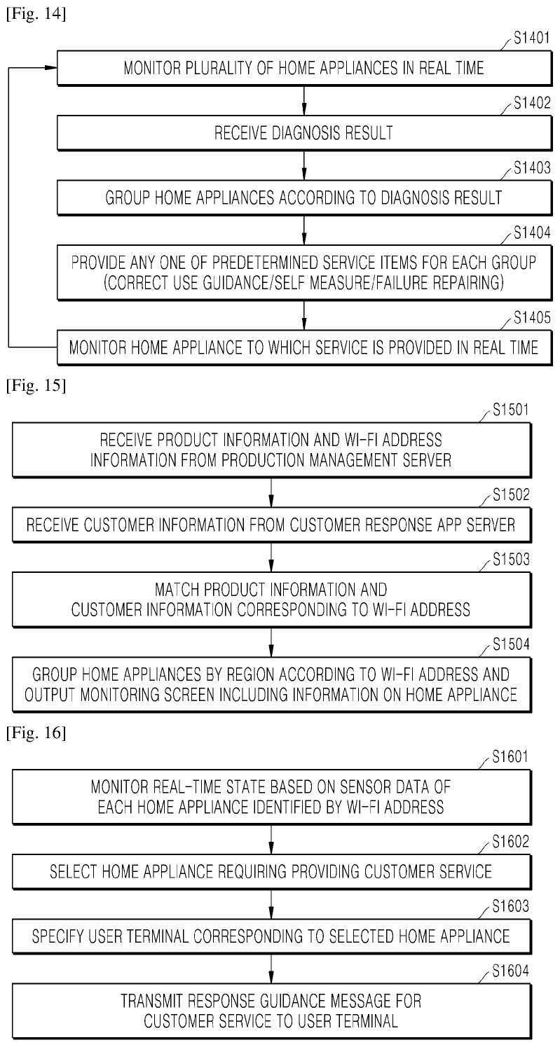

FIG. 14 is a flowchart of a method for managing a plurality of home appliances by real-time monitoring by a customer service providing system according to an embodiment.

In step S1401, the customer service providing system 100 (e.g., the monitoring server 104) may perform real-time monitoring for the plurality of home appliances 200. The customer service providing system 100 may request additional data for the home appliance 200 to the product diagnosis server 103 when necessary, or request checking whether the operation is abnormal, based on the information on the home appliance 200 received from the product diagnosis server 103.

In step S1402, the monitoring server 104 may receive a diagnosis result such as an abnormal operation for the home appliance 200 from the product diagnosis server 103. For example, the monitoring server 104 may periodically identify a normal operation of the home appliance, an abnormal operation according to the inexperienced use, an abnormal operation according to a misuse, and an abnormal operation according to the failure, and receive an abnormal operation alarm from the product diagnosis server 103 immediately after the abnormal operation occurs.

In step S1403, the monitoring server 104 may group the plurality of home appliances into one or more according to diagnosis results of the plurality of home appliances 200 which is monitored in real time. For example, the home appliances 200 may be grouped to three groups according to the inexperienced use/misuse/failure state of the home appliance. In various embodiments, the monitoring server 104 may classify the home appliances 200 by region according to the installation location of the home appliance 200. For example, the monitoring server 104 may group the home appliances 200 according to the nation.

In step S1404, the monitoring server 104 may provide anyone of predetermined service items for each group to the home appliance 200. For example, a correct use explanation response/a self-measure guidance/an outcall measure service of the professional engineer may be provided to the home appliance 200 in response to the inexperienced use/misuse/failure state of the home appliance 200. The monitoring server 104 may provide the service by preemptively attempting a communication connection to the user terminal.

In step S1405, the monitoring server 104 may monitor the home appliance 200 to which the customer service is provided in real time. The monitoring server 104 may determine whether a cause of the abnormal operation is resolved by checking whether the home appliance 200 normally operates during a predetermined period after providing the service. The monitoring server 104 may request a state checking or diagnosis result for the home appliance 200 to the product diagnosis server 103 and feeds back the result to identify whether a problem for the home appliance 200 is resolved. For example, the monitoring server 104 checks the real-time state of a home appliance 200 in which a lack of cooling power is sensed and the outcall service is conducted to check whether the home appliance 200 normally operates without the request from the customer.

The monitoring server 104 may repeated each step of FIG. 14 in order to manage a plurality of home appliances 200.

FIG. 15 illustrates a flowchart of a method for monitoring a home appliance in real time by the customer service providing system according to an embodiment.

In step S1501, the customer service providing system (e.g., the monitoring server 104) may receive the product information and the Wi-Fi address generated in the process of manufacturing the home appliance 200 from the production management server 101. The product information may include at least one a manufacturing number, a model name, a production factory, a production line, a production date, or main component information.

In step S1502, the monitoring server 104 may receive customer for the user of the home appliance 200 from the customer response app server for the home appliance 200. The customer information may include at least one of a name, a phone number, an address, an email, an ID, a purchased home appliance mode name, a purchase date, or a purchased home appliance manufacturing number.

In step S1503, the monitoring server 104 may match the product information and the customer information corresponding to the Wi-Fi address with each other.

In step S1504, the monitoring server 104 groups the home appliances by region according to the Wi-Fi address to output a monitoring screen including the information on the home appliance 200 to the display device. The information on the home appliance 200 may include at least one of the product information, the customer information, real-time state information of the home appliance 200, or information on the abnormal operation of the home appliance 200, and may be generated based on the sensor data collected in real time by the sensor included in the home appliance 200. The monitoring server 104 may receive the real-time state of the home appliance 200 or whether the home appliance 200 abnormally operates in response to sensing the abnormal operation of the home appliance 200 by analyzing the sensor data from the home appliance diagnosis server 103, and the information on the abnormal operation may include at least one of an abnormal operation according to the inexperienced use, an abnormal operation according to misuse, or an abnormal operation according to the failure. The monitoring server 104 may provide the customer service to a user terminal specified according to the customer information of the home appliance 200 based on the information on the abnormal operation of the home appliance 200, and provide a subsequent measure of the customer service by checking whether the home appliance 200 abnormally operates from the home appliance diagnosis server 103 after the customer service is provided.

The monitoring screen may include a first area including one or more search items for searching for the home appliance 200 and a second area displaying the home appliance list according to a search operation, and one or more search items may include at least one of the product information, the customer information, a data collection period, real-time state information of the home appliance, or the information on the abnormal operation of the home appliance.

FIG. 16 illustrates a flowchart of a method for providing a customer service in response to a failure of a home appliance according to an embodiment.

In step S1601, the customer service providing system 100 may monitor the real-time state based on the sensor data of each home appliance identified by the Wi-Fi address. Real-time data may be received from the home appliance according to communication activation of the home appliance. The home appliance 200 may be set at a manufacturing time point so as to transmit one or more predetermined data among the sensor data collected by one or more sensors to the customer service providing system 100 when network setting is completed after product installation. The type of periodically sensor data, a transmission period, etc., may be changed by receiving the control signal for transmission of the sensor data from the customer service providing system 100.

In step S1602, the customer service providing system 100 may select a home appliance requiring providing the customer service among home appliances which are being monitored. For example, it may be determined that the customer service needs to be provided to the home appliance of which abnormal operation is sensed.

In step S1603, the customer service providing system 100 may specify the user terminal corresponding to the selected home appliance by using the customer information. The home appliance is identified by the Wi-Fi address, and the customer information includes the Wi-Fi address for the purchased home appliance.

In step S1604, the customer service providing system 100 may transmit the response guidance message for the customer service to the user terminal. The response guidance message may include a detailed guidance for the subsequent measure according to the abnormal operation, and for example, the response guidance message according to the failure may provide a function to guide the professional engineer visit schedule, and accept or change the visit schedule.

The embodiments described above may be implemented by hardware components, software components, and/or combinations of the hardware components and the software components. For example, the devices, methods, and components described in the exemplary embodiments may be implemented by using one or more universal computers or special-purpose computers like any other devices a processor controller, an arithmetic logic unit (ALU), a digital signal processor, a microcomputer, a digital signal processor, a field programmable gate array (FPGA), a programmable logic unit (PUL), a microprocessor, or any other device capable of executing and responding to an instruction. A processing device may perform an operating system (OS) and one or more software applications executed on the operating system. Further, the processing device may access, store, operate, processing, or generate data in response to execution of software. For convenience of understanding, there is a case where it is described that one processing device is used, but those skilled in the art may know that the processing device may include a plurality of processing elements and/or a plurality of types of processing elements. For example, the processing device may include a plurality of processors or one or more processors or one controller. Further, another processing configuration such as a parallel processor is also available.

The software may include a computer program, code, instructions, or a combination of one or more thereof, and configure the processing unit to operate as desired, or instruct a processing device independently or collectively. Software and/or data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer readable recording media.

The method according to the exemplary embodiment may be implemented in a form of a program command which may be performed through various computer means and recorded in the computer readable medium. The computer readable medium may include a program command, a data file, a data structure, etc., singly or combinationally. The program command recorded in the medium may be specially designed and configured for the exemplary embodiment, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler. The hardware device may be configured to be operated with one or more software modules in order to perform the operation of the exemplary embodiment and vice versa.

As described above, although the exemplary embodiments have been described by the limited exemplary embodiments and drawings, those skilled in the art can perform various technical modifications and variations from the description. For example, the described techniques are performed in a different order from the described method, and/or components such as a system, structure, device, circuit, etc., described are collected or combined in a form different from the described method, or even if the components are replaced or substituted by other components or an equivalent, an appropriate result can be achieved. Therefore, other implementations, other embodiments and claims and equivalents fall within the scope of the following claims.

1. A real-time monitoring system of home appliances, comprising:
receiving product information and a Wi-Fi address generated in a manufacturing process from a production management server of the home appliance;
receiving customer information for a user of the home appliance from a customer response app server for the home appliance;
matching the product information and the customer information corresponding to the Wi-Fi address with each other; and
grouping the home appliances by region according to the Wi-Fi address to output a monitoring screen including the information on the home appliance to a display device.

2. The real-time monitoring system of home appliances of claim 1, wherein the information on the home appliance includes at least one of the product information, the customer information, real-time state information of the home appliance, or information on an abnormal operation of the home appliance.

3. The real-time monitoring system of home appliances of claim 2, wherein the monitoring screen includes a first area including one or more search items for searching for the home appliance and a second area displaying a home appliance list according to the search operation, and
the one or more search items include at least one of the product information, the customer information, a data collection period, real-time state information of the home appliance, or the information on the abnormal operation of the home appliance.

4. The real-time monitoring system of home appliances of claim 1, wherein the product information includes at least one a manufacturing number, a model name, a production factory, a production line, a production date, or main component information, and
the customer information includes at least one of a name, a phone number, an address, an email, an ID, a purchased home appliance mode name, a purchase date, or a purchased home appliance manufacturing number.

5. The real-time monitoring system of home appliances of claim 2, wherein the real-time state information of the home appliance or the information on the abnormal operation of the home appliance is generated based on sensor data collected in real time by a sensor included in the home appliance.

6. The real-time monitoring system of home appliances of claim 5, wherein a real-time state of the home appliance or whether the home appliance abnormally operates is received in response to sensing the abnormal operation of the home appliance by analyzing the sensor data from a home appliance diagnosis server.

7. The real-time monitoring system of home appliances of claim 2, wherein the information on the abnormal operation of the home appliance includes at least one of an abnormal operation according to inexperienced use, an abnormal operation according to misuse, or an abnormal operation according to a failure.

8. The real-time monitoring system of home appliances of claim 2, wherein a customer service is provided to a user terminal specified according to customer information of the home appliance based on the information on the abnormal operation of the home appliance.

9. The real-time monitoring system of home appliances of claim 8, wherein a subsequent measure of the customer service is provided by checking whether the home appliance abnormally operates from the home appliance diagnosis server after the customer service is provided.

10. A customer service providing system for home appliances, comprising:
monitoring a real-time state of each home appliance based on sensor data collected by a sensor included in each home appliance identified by a Wi-Fi address;
selecting at least one home appliance requiring providing a customer service according to the real-time state of each home appliance; and
transmitting a response guidance message for the customer service to each user terminal specified by customer information corresponding to at least one selected home appliance.

11. The customer service providing system for home appliances of claim 10, wherein a customer service request is received from the user terminal in response to the response guidance message for the customer service, the home appliance corresponding to the user terminal is searched, and a monitoring screen for a real-time state of the searched home appliance is output to a display device.

12. The customer service providing system for home appliances of claim 10, wherein the abnormal operation for each home appliance is sensed based on sensor data collected by a sensor included in each home appliance identified by a Wi-Fi address, and
the customer service is provided to the home appliance of which abnormal operation is sensed.

13. A method for providing a preemptive customer service based on geographical location information of a home appliance identified by a Wi-Fi address, the method comprising:
receiving a visit service providing request for one or more home appliances of which abnormal operation is sensed while monitoring a plurality of home appliances;
identifying a current location of each of the one or more home appliances based on Wi-Fi information of the one or more home appliances;
classifying the one or more home appliances for each of one or more regions based on current locations of the one or more home appliances;
setting a visit schedule for one or more home appliances included for each region; and
providing a professional engineer outcall service according to the visit schedule.

14. The method of claim 13, wherein in the setting of the visit schedule, a shortest route with the current location of each of one or more home appliances as a vertex is searched by using a shortest route algorithm, and a professional engineer outcall service route is set in response to the shortest route.

15. The method of claim 13, wherein the Wi-Fi address is a MAC address.
